(19) United States
(12) Patent Application Publication
(10) Pub. No.: US 2013/0232032 A1
(43) Pub. Date: Sep. 5, 2013

(54) Methods and Systems for Performing Mobile Collections

(71) Applicants: Preeti Chaturvedi, Union, NJ (US); David Fleming, Wicklow (IE); Michael Knorr, Fairfield, CT (US); Tomasz Smilowicz, New York, NY (US); Thomas Ko, Monroe Twp., NJ (US); Gerard Doyle, Dublin (IE)

(72) Inventors: Preeti Chaturvedi, Union, NJ (US); David Fleming, Wicklow (IE); Michael Knorr, Fairfield, CT (US); Tomasz Smilowicz, New York, NY (US); Thomas Ko, Monroe Twp., NJ (US); Gerard Doyle, Dublin (IE)

(73) Assignee: Citibank Europe plc, Dublin (IE)

(21) Appl. No.: 13/409,767

(22) Filed: Mar. 1, 2012

(51) Int. Cl. G06Q 30/06

(52) U.S. Cl. 705/26.41

(57) ABSTRACT

Methods and systems for performing mobile collections utilize computer hardware and software for receiving delivery information including, for example, an agent identifier, a delivery identifier and details of a scheduled delivery, and a buyer identifier. Upon receiving the delivery identifier and a submit request from a communication device of the agent, an authorization request is sent to a communication device of the buyer. On receiving the buyer identifier and an authorization response from the communication device of buyer, a settlement request for the delivery is sent to a banking network. Thereafter, payment for the delivery is received in an account of the supplier.

### FIELD OF THE INVENTION

The present invention relates generally to the field of financial transactions, and more particularly to methods and systems for performing mobile collections using mobile communication devices.

### BACKGROUND OF THE INVENTION

Currently, in the Fast Moving Consumer Goods (FMCG) sector, consumer goods, such as beverages, tobacco products, snacks, candy and some home goods, are delivered to wholesalers as well as end retailers of a certain size by distributors throughout the world. Generally, for multiple reasons, the makers of these goods and intermediaries in their distribution chain do not have an electronic financial relationship with the retailers to whom they deliver such goods. Such retailers are typically small to medium-sized stores, or they may be other small retail organizations that are larger than the latter but smaller than the large well-known international or national retail chains. These types of business-to-business transactions are common not just within the FMCG industry, but also with other industries such as insurance, food delivery, and many local country-specific segments.

Typically, when goods are delivered to these retailers, a financial transaction occurs in which the retailer (buyer) pays for the goods in cash to the person making the delivery (seller) at the point of sale, or in some cases is issued an invoice for later payment. This mode of transaction is very common in all countries, both developed and emerging. However, the existing transaction model has an inherent variety of problems that are globally common as well. A few of those issues are the following.

The Days Sales Outstanding (DSO) for goods delivered by this mechanism tends to a lengthy one where risk resides in route for the cash to come back to the central account of the seller. Either the cash is not collected at the time of delivery, or if it is collected at the time of delivery, the collected cash comes back to a depot, where it is counted and reconciled back to the retailer or banked at the distributor's bank, shipped to some other central location, and then eventually paid to the seller. Thus, there may be a considerable delay between the time the cash is collected and the time when it is actually banked, which causes a corresponding increase in DSO.

There are also a number of inherent issues in handling cash in a delivery vehicle and by the delivery person. Safety of the person operating in this environment is a very important issue.

Also, having a large amount of cash by a delivery person in an operating vehicle without close watch on the process leaves room for fraud/shrinkage risks.

Since the bills and coins that may be collected are considered as ‘dirty’ money, meaning those bills may have been worn out or torn apart in some areas, there is an inconvenience in accurately counting this money in a retailer environment, a central depot, and in the banks. Again, these problems currently exist for global customers of a financial institution in every region of the world.

A few companies have adopted solutions that attempt to streamline their order-to-cash processes. One such attempt involves paying for a service using a mobile phone account called ‘phone-bill service’. Typically, payments made via a mobile phone are billed to the payor to be paid in the future either via the payor's monthly bill or by using the payor's call credit on a pre-paid phone. The ‘phone-bill service’ basically transfers the collection duty to the mobile network operator (MNO). However, in such schemes, the vendor of such service does not receive payment until the MNO settles up with the vendor at some time much later than the time of the transaction with a fee suitable to protect the MNO in the risk that it undertakes. Due to that risk, most MNOs do not presently offer these solutions.

Another such attempt is use of handheld devices by courier/delivery companies to help track deliveries and have the receiver “sign” for the goods on delivery. This scheme creates a record which allows traceability of the goods, but does not handle any payment aspects of the delivery. Most deliveries made by such companies are made on behalf of a third party, who has been paid for the goods and shipping costs in advance. In these cases the courier/delivery company is not typically involved in the collection of any payment from the purchaser of the goods and cannot make any changes to the delivery at point of delivery. Therefore, a substantial amount of collection is presently left to be done via the old fashioned method of cash collection.

Cases in which a courier/delivery company is required to collect a payment represent a classic cash-on-delivery scheme. In such cases, the courier may have hand-held point-of-sale equipment that allows the courier to receive a payment using a credit card, or the courier may accept cash or a check payment. However, in such cases, the courier/delivery company that accepts the payment must then pass it on to the vendor at a later time and assumes responsibility for the same issues around cash as identified above.

Therefore, it can be seen that there are fundamental issues in the business-to-business collection model because cash is the most effective way to do so and cash is the root of all issues. Many solutions have been designed and adopted by many corporations attempting to reduce the risk of cash collection and to optimize the process. However, none have fundamentally impacted the industry to reduce cash collections and to begin seeing a benefit of digital collections.

Mobile phones have been adopted by most individuals both in developed and emerging countries in the twenty-first century as indicated by the estimated number of more than 5.5 billion people worldwide who possess a mobile phone. Thus, the mobile phone is the single most widely adopted piece of digital equipment connected via network in the history of mankind. Therefore, replacing cash with digital transactions capability via mobile phone with real-time connectivity between central seller, delivery person and buyer and real-time confirmation of the funds transfer is not only an interesting idea but also a realistic model that may finally bring evolution in the business-to-business financial transaction model.

### SUMMARY OF THE INVENTION

Embodiments of the invention employ computer hardware and software, including, without limitation, one or more processors coupled to memory and non-transitory computer-readable storage media with one or more executable programs stored thereon which instruct the processors to perform the methods and systems for performing mobile collections described herein.

Embodiments of the invention propose a method for performing mobile collections that may involve receiving, using a file processor, delivery information consisting at least in part of an agent identifier for at least one agent of a supplier, a delivery identifier and details for at least one scheduled delivery by the at least one agent to at least one buyer, and a buyer identifier for the at least one buyer.

Thereafter, using an internal mobile portal processor, the delivery identifier and a submit request associated with the delivery identifier may be received from a communication device of the at least one agent. Using a mobile payment processor, an authorization request for the delivery associated with the delivery identifier may be sent to a communication device of the at least one buyer, and likewise using the mobile payment processor, the buyer identifier and an authorization response for the delivery associated with the delivery identifier may be received from the communication device of the at least one buyer. A settlement request for the delivery associated with the delivery identifier may be sent, using the mobile payment processor, to a banking network, and payment for the delivery associated with the delivery identifier may be received, also using the mobile payment processor, in an account of the at least one supplier. Payment into the account of the supplier may be done by the settlement service of the financial institution.

According to embodiments of the invention, receiving the delivery information may involve receiving the delivery information from the supplier, and more specifically, from an enterprise resources planning system processor of the supplier. Receiving the delivery information may further involve, for example, receiving order information related to the delivery information by the enterprise resources planning system processor of the supplier from an enterprise resources planning system of the buyer. Receiving the order information may involve translating the order information into a file format of the file processor.

In embodiments of the invention, receiving the delivery identifier from the communication device of the agent may involve receiving the delivery identifier from the agent's mobile phone located at premises of the buyer. In further embodiments, receiving the submit request may involve presenting the details for the at least one scheduled delivery on the agent's mobile phone, and receiving the submit request may further involve receiving delivery detail adjustments entered by the agent on the agent's mobile phone.

In further embodiments, sending the authorization request may involve receiving the details for the scheduled delivery from a mobile collections system processor, and receiving the details for the scheduled delivery may involve associating the delivery identifier with the details for the at least one scheduled delivery. Additionally, associating the delivery identifier with the details for the at least one scheduled delivery may involve applying transaction rules to the details for the at least one scheduled delivery. In other embodiments, sending the authorization request may involve sending a message to the buyer's mobile device requesting verification of the delivery.

In still further embodiments, receiving the buyer identifier and authorization response may involve receiving the buyer identifier and authorization response entered on the buyer's mobile phone. In addition, receiving the buyer identifier and authorization response may involve verifying the buyer identifier. In another embodiment, sending the settlement request may involve sending a transaction confirmation message to a financial institution processor.

In other embodiments, sending the settlement request may involve sending a transaction confirmation message to the buyer's communication device. Further, sending the settlement request may involve sending the settlement request with transaction information for the delivery via a banking network to a processor of the buyer's bank. Sending the settlement request may also involve sending a request for a transfer of funds from an account of the buyer to an account of the mobile payment processor.

An aspect of embodiments of the invention may involve, for example, a method for performing mobile collections in a provider context, such as a provider of insurance services. It is to be understood that such aspect is not limited to providers of insurance but that embodiments of the invention include any and all types of providers. Such aspect may involve, for example, receiving, using a file processor, collection information consisting at least in part of an agent identifier for at least one agent of a provider, a collection identifier and details for at least one scheduled collection by the at least one agent from at least one customer, and a customer identifier for the at least one customer.

Further, according to such aspect, the agent identifier, the collection identifier and a submit request associated with the collection identifier may be received from a communication device of the at least one agent using an internal mobile portal processor. Thereafter, using a mobile payment processor, an authorization request for the collection associated with the collection identifier may be sent to a communication device of the at least one customer. Likewise using the mobile payment processor, the customer identifier and an authorization response for the collection associated with the collection identifier may be received from the communication device of the at least one customer. Also using the mobile payment processor, a settlement request for the collection associated with the collection identifier may be sent to a banking network, and payment for the collection associated with the collection identifier may be received in an account of the provider using the mobile payment processor.

Embodiments of the invention provide a global platform that replaces physical cash collection and allows a client of a financial institution to request payment for goods from its customers using a mobile device. Aspects of embodiments of the invention provide the client and its customers with the flexibility to support multiple payment options, including credit cards, prepaid cards, mobile wallets and local country specific mobile payment instruments. Other aspects enable the financial institution to target market opportunities in the FMCG industry where suppliers make regular deliveries to retailers on a COD basis. Additional aspects enable the financial institution to replace the COD process with a secure cashless transaction that may open up new markets and revenue streams for the financial institution. Still other aspects offer a more efficient delivery-transaction-payment process, decrease fraud, increase employee safety, reduce operational overhead, and provide quicker availability of funds to clients of the financial institution.

A solution provided by embodiments of the invention applies mobile technologies and platforms to the global retail delivery scenario to remove the cash transaction and replace it with an electronic transaction, which is initiated by a mobile communication device, such as a mobile phone, and which utilizes various technologies within the mobile phone. For the widest possible reach, embodiments of the invention provide a software platform and global capability that enables initiation of mobile collections using a variety of mobile technologies. For example, in one aspect, a transaction and collection process may be initiated using Short Message Service (SMS). In other aspects, mobile web applications may be provided which allow initiation of mobile payment transactions using a mobile HTML page running on the mobile phone. In the either scenario, further details may be provided to the person making the delivery to enrich the transaction. Embodiments of the invention may employ native applications on mobile phones, such as applications available for APPLE® and ANDROID®. Further aspects may utilize tablet devices for drivers who are delivering the goods.

Embodiments of the invention remove physical cash from a transaction and replace it with an electronic transaction, which may be initiated simply by the driver arriving at a retail store for a delivery and which may occur within the banking system. According to embodiments of the invention, a transaction may be verified by the retailer receiving a notification of the delivery and prompting the retailer to confirm the delivery with a one-time password or PIN or some other identification mechanism. Thus, the retailer is able to verify that funds can be transferred from the retailer's account to the supplier's account. According to embodiments of the invention, distributors may only be able to collect on behalf of suppliers. The distributor may not have a collection destination account set up in the financial institution. The supplier may be linked to many different distributors, and as a result, funds may only be deposited into the supplier destination account. As a result, the financial institution as holder of the supplier's destination account, and possibly as holder of the retailer's source account, may see revenue generation from access to flows of cash and deposits which is not currently available. Thus, embodiments of the invention may provide a substantially shorter DSO for the distributor, potential revenue generation for the financial institution, and a more securely authorized transaction for the retailer.

These and other aspects of the invention will be set forth in part in the description which follows and in part will become more apparent to those skilled in the art upon examination of the following or may be learned from practice of the invention. It is intended that all such aspects are to be included within this description, are to be within the scope of the present invention, and are to be protected by the accompanying claims.

### BRIEF DESCRIPTION OF THE DRAWINGS

FIG. 1 is a schematic diagram that illustrates an overview example of key components and the flow of information between key components of the mobile collections method and system for embodiments of the invention;

FIGS. 2a and 2b show a flow chart which illustrates an example of the mobile collections process for embodiments of the invention; and

FIG. 3 is a flow chart that illustrates an overview example of the mobile collections process shown in FIGS. 2a and 2b for embodiments of the invention.

### DETAILED DESCRIPTION

Reference will now be made in detail to embodiments of the invention, one or more examples of which are illustrated in the accompanying drawings. Each example is provided by way of explanation of the invention, not as a limitation of the invention. It will be apparent to those skilled in the art that various modifications and variations can be made in the present invention without departing from the scope or spirit of the invention. For example, features illustrated or described as part of one embodiment can be used in another embodiment to yield a still further embodiment. Thus, it is intended that the present invention cover such modifications and variations that come within the scope of the invention.

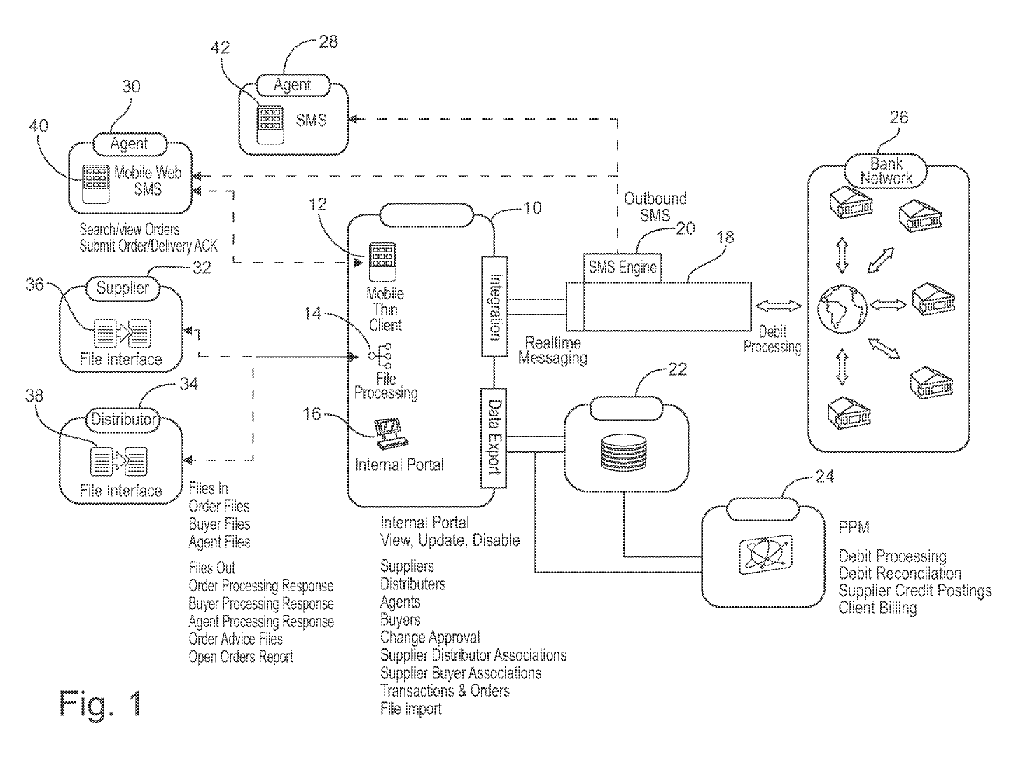

FIG. 1 is a schematic diagram that illustrates an overview example of key components and the flow of information between key components of the mobile collections method and system for embodiments of the invention. Referring to FIG. 1, the mobile collection system 10 for embodiments of the invention may comprise, for example, a mobile thin client processor 12, a file processor 14, and an internal portal processor 16. The mobile collections system may also employ external interfaces, such as a mobile payment processor 18 with a messaging engine 20, a data warehouse database 22, a payment processing module 24, and a banking network 26. It is to be understood that an external customer identification or know-your-customer (KYC) system that provides sanctions checking capabilities (not shown) may be employed in embodiments of the invention.

Referring further to FIG. 1, participants may include a retailer or buyer 28, a driver or agent 30, a supplier 32, and a distributor 34. Generally, embodiments of the invention propose that both the distributor 34 and the retailer or buyer 28 are registered users. It is contemplated that the distributor 34 may be a customer of the financial institution which provides the mobile collections system 10 for embodiments of the invention. While it may also be preferable for the retailer or buyer 28 to be a customer of the financial institution, it is not considered to be mandatory.

In embodiments of the invention, information may be input into the file processor 14 of the mobile collections system 10 through a file interface 36 or 38 of the supplier 32 and/or the distributor 34 via which information about agents 30 and buyers 28 and orders and deliveries to be made are uploaded. Once uploaded, the delivery information is available to the agent 30 when the agent goes on the road with his or her delivery vehicle to deliver goods to a buyer 28. The agent 30 may use a thin client of his or her mobile communication device 40, such as the agent's mobile phone, to access deliveries that the agent will be making to the buyer 28.

There are relationships between the suppliers 32, the buyers 28, and the agents 30, which are key to the occurrence of various validations in embodiments of the invention. For example, a buyer 28 may potentially be in the mobile collections system 10 more than once if the buyer is being supplied by more than one supplier 32. Those relationships are managed by the way in which data is uploaded onto an internal data module of the mobile collections system 10.

When an agent 30 uses the mobile thin client interface of his or her mobile communications device 40, the agent may search for a particular delivery. Because the agent 30 knows to which buyer's premises he or she is driving to deliver the goods, the agent may use the mobile thin client interface of his or her mobile communications device 40 to search for the delivery identifier (ID) associated with the particular buyer 28. That information may have been uploaded from file information in an Enterprise Resources Planning (ERP) system of the supplier 32.

When the agent 30 arrives at the buyer's location, the agent may search for information about the particular delivery and may press a ‘submit’ button on the agent's mobile communication device 40. A submit request may then be sent from the agent's mobile device 40 to the mobile thin client processor mobile collection processor 12 of the mobile collections system 10. At this point, validations may be applied to ensure, for example, that all parties are active and eligible. The submit request may in turn be sent to the mobile payment processor 18. Upon receipt of the submit request, the mobile payment processor 18 may send a SMS message via its SMS engine 20 to a buyer's communication device 42, such as the buyer's mobile phone, requesting authorization.

According to embodiments of the invention, the SMS message may function as a handshaking type of mechanism to receive an authentication from the buyer 28 assuring that the delivery is proper. The buyer 42 may enter an identifier, such as a Personal Identification Number (PIN), on his or her mobile device 42 and return that information to the mobile payment processor 18 by SMS message. In turn, the mobile payment processor 18 may communicate a request to the banking network 26 for payment to be made. At that point, the mobile collections system 10 may poll the mobile payment processor 18 as well for responses to the original submit request. When the processing concludes, a collective message may be sent by the mobile payment processor 18 to all participants advising either that the processing was successful or was not successful, as the case may be. The mobile payment processor may send a success message to the buyer and a success WS-Reliable message to the mobile collection processor 12. The mobile payment processor may not send a message to the agent.

When a success message is received from the mobile payment processor 18 by the mobile payment system 10, the mobile collections system may instigate a settlement request back through the payment-processing module 24 to the banking network 26. Upon receiving the settlement request by the banking network 26, payment for the delivery may be transferred from the buyer's account to the account of the mobile payment processor 18 which may be held within the financial institution. The mobile payment processor 18 may maintain a single account at the financial institution into which all payments that are received through the mobile collection system 10 are deposited. It is to be understood that the mobile collections system may send an initial request to the payment processor to request collection of payment and thereafter may simply poll the payment processor for a status update without initiating a further settlement request.

When a successful collection of a payment is concluded, a request may be sent to the payment system to perform a settlement to the supplier's account, and the payment may be posted from the account of the payment-processing module 24 to the supplier's account within the financial institution. Therefore, the payment for the delivery is in the supplier's account within one or two days of the actual delivery, and the DSO is reduced to only one or two days.

Referring once more to FIG. 1, the data warehouse database 22 stores all records, for example, to comply with various requirements to store transaction data and transaction data updates. On the agent side, as previously noted, the agent's mobile device 40 may be the agent's mobile phone, tablet device or any other suitable mobile communication device. It is not necessary to install any special software on the agent's mobile device 40. Instead, the agent 30 may simply use the web browser on his or her mobile device 40 as a thin client application that is serviced by a mobile thin client processor 12 behind a firewall within the financial institution. On the buyer's side, the buyer 28 may likewise simply use the browser on the buyer's mobile device 42, such as the buyer's mobile phone or tablet device, as a thin client to send, receive and respond to text messages using SMS, which may be handled by the SMS engine 20 within the mobile payment processor 18. It is to be understood, however, that embodiments of the invention may employ an application model on one or both of the agent's and buyer's mobile devices 40, 42 instead of using the agent's and buyer's mobile device browsers as thin clients.

Referring again to FIG. 1, the mobile collections internal portal processor 16 is a core application that resides on production servers of the financial institution. The mobile collections internal portal processor 16 may be based on a UNIX operating system, such as AIX system, using an application server such as WebSphere application server to service requests that come into the mobile collections system 10 from external sources. In addition, various firewalls and protection mechanisms may be employed to ensure the security of the application.

Referring once again to FIG. 1, in the file processing function of the mobile collections platform, files may be uploaded by suppliers 32 and/or distributors 34 through an online banking platform, such as the CITIDIRECT® banking platform, and arrive via various queuing mechanisms. Such files may be used to populate a data module which may then be used internally when populating a Graphical User Interface (GUI) for the agents 30.

Embodiments of the invention employ business rules that determine for which supplier an agent may or may not be permitted to deliver. For example, business rules may govern a particular driver or agent who is registered with a particular supplier, such that the particular driver is not permitted to deliver goods belonging to a different supplier. In addition, embodiments of the invention may employ various rule sets governing what a particular agent 30 may be allowed to do, such as daily delivery limits to protect against fraud. In certain areas, particular drivers may be allowed to deliver no more than a fixed quantity in a particular day or in a particular 24-hour period. There may also be various checks, balances and validations that are performed around the file processes.

Referring still again to FIG. 1, the internal portal processor 16 may be provided for the financial institution's internal support organization and operations personnel so that they may have a view of what is happening in the system for embodiments of the invention. Thus, such personnel may see the database 22 and its contents, such as files that have been uploaded, deliveries that are currently in progress, deliveries that are outstanding, and which transactions have been settled and which have not. In addition, such personnel may access the database 22 to configure new suppliers and new distributors.

As is self-apparent from the forgoing discussion, external users of the mobile collections system 10 may include, for example, suppliers 32, distributors 34, agents 30 and buyers 28. Suppliers 32 and distributors 34 may be customers of the financial institution which supply the agent information to the financial institution. The suppliers 32 and distributors 34 may have a deposit account with the financial institution into which collected money may be transferred. An agent 30 may work on behalf of a supplier 32/distributor 34, to deliver goods to buyers 28 and facilitate the collection of payment for the goods by interacting with the mobile collections system 10 using a mobile device 40. The buyers 30 may register with the mobile collections system 10. The buyers' information may be supplied to the financial institution by a mobile payment processor 18.

A participant in the process for embodiments of the invention may include, for example, a FMCG distribution center 34, which may identify both a supplier 32 and one or more divisions in a case in which one supplier may actually have different accounts for different divisions of the supplier's business. Thus, there may a single overall supplier 32 with several different divisions. In embodiments of the invention, such a supplier and its divisions may be considered as a single entity. Participants may include for example a financial institution and its customers, such as FMCG companies as distributors 34.

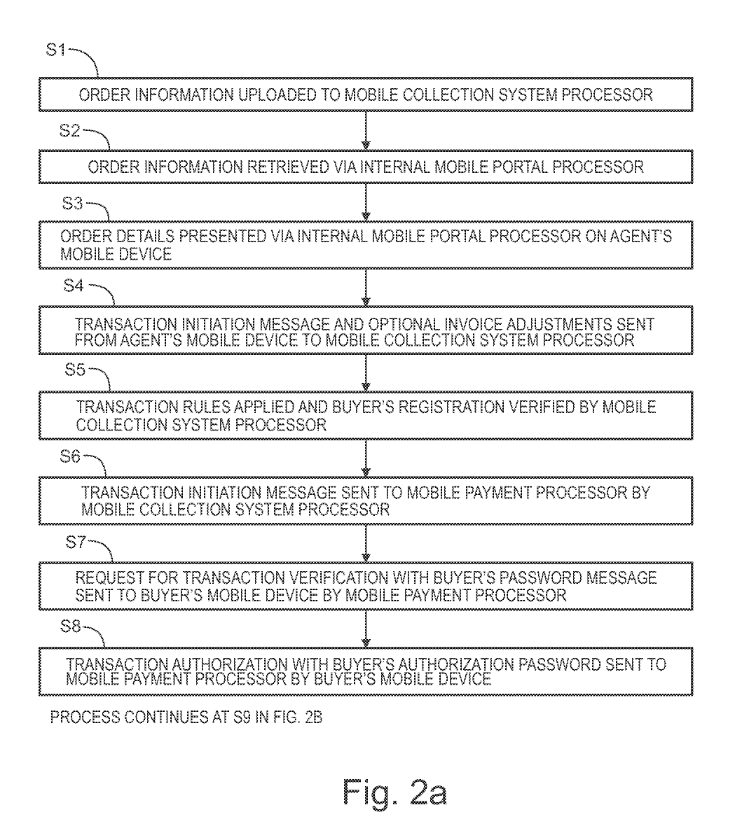

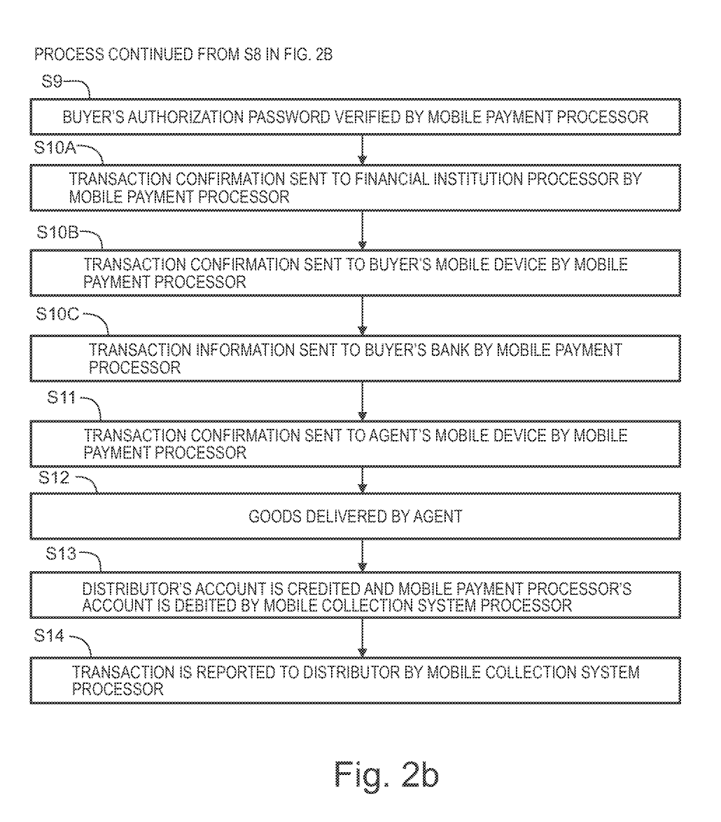

FIGS. 2a and 2b show a flow chart which illustrates an example of the mobile collections process for embodiments of the invention. Referring to FIG. 2a, at S1, order information may be uploaded to a mobile collection system processor. For example, a distributor 34 may configure the mobile collection system 10 with its list of delivery agents 30 and buyers 28 and order information. Such configuration may typically be performed via exported files from an ERP system of the distributor 34. The distributor 34 may preload information consisting of data about the agents 30, the buyers 28, and the orders into the file processor 14 of the mobile collections system 10. In addition, the buyer 28 may send an order, for example, through an ERP system of the buyer to the supplier 32. The buyer's order may be translated into a file format of the file processor 14 of the mobile collections system 10 and be uploaded to the file processor 14.

Referring further to FIG. 2a, at S2, the order information may be retrieved via the internal mobile portal processor 16. Thus, the agent 30 who is making a delivery to the premises of a buyer 28 may use the agent's mobile device 40, such as the agent's mobile phone, to log into the mobile internal portal processor 16 of the mobile collections system 10 and retrieve the order information by entering an identifier, such as an order number on the agent's mobile device 40. At S3, the order details may be presented via the internal mobile portal processor 16 on the agent's mobile device 40. For example, when the agent 30 enters the order number on the agent's mobile phone 40, the order details may be presented to the agent on his or her mobile phone 40. At S4, a transaction initiation message and optional invoice adjustments may be sent from agent's mobile device 40 to a mobile collection system processor 14. If the agent 30 is satisfied with the order details, the agent may initiate the transaction and may also perform invoice adjustments. For example, embodiments of the invention may provide capabilities to allow the agent 30 to adjust amounts and order details.

Referring again to FIG. 2a, the agent 30 may initiate the transaction at S4, for example, by clicking or pressing a button, tab, checkbox or the like on the agent's mobile phone 40 to send a submit collections request to the mobile collection system processor 14. At S5, the mobile collection system processor 14 may then apply any one or more of a number of the transaction rules previously mentioned and verify the buyer's registration. At S6, a transaction initiation message may be sent to the mobile payment processor 18 by the mobile collection system processor 14. Thus, if the transaction rules are satisfied, and if the delivery is being made to the correct buyer 28, the mobile collection system processor 14 may send details of the transaction to the mobile payment processor 18 for confirmation and action. At S7, the mobile payment processor 18 may then send a transaction verification request to the buyer's mobile device 42 to verify the delivery by entering a unique indicator such as the buyer's password on the mobile device.

Referring once more to FIG. 2a, at S8, upon receiving the request, the buyer 28 may evidence the buyer's authorization for the transaction by entering the correct buyer's password on the buyer's mobile phone 42 and sending the password via SMS on to the mobile payment processor 18. Referring to FIG. 2b, at S9, the mobile payment processor 18 may receive the password and verify that the password is correct for the particular buyer 28. At S10a, the mobile payment processor 18 may send a transaction confirmation message to a processor of the financial institution and, at S10b, to the buyer's mobile phone 42. In addition, at S10c, the mobile payment processor 18 may send the transaction information via a banking network 26 to a processor of the buyer's bank for processing with a request for a transfer of funds from the buyer's account to the account of the mobile payment processor 18. Thereafter at S11, the mobile collection processor 12 may send a transaction confirmation message via SMS to the agent's mobile device 40 confirming the collections request. Upon receipt of the confirmation, at S12, the agent 30 may complete the delivery to the buyer. At S13, the account of the supplier may be credited, and the mobile payment processor's account may be debited by the mobile collection system processor 14. At S14, the transaction may be reported to the supplier 32 by the mobile collection system processor 14.

There are various failure options that may result in a delivery not occurring, such as if the buyer is not registered or is not registered correctly or if for some reason the banking system or the mobile payment processor 18 is offline. Such failure modes which may occur are handled by each system in its own way to ensure that a transaction is suitably concluded or recessed without financial loss.

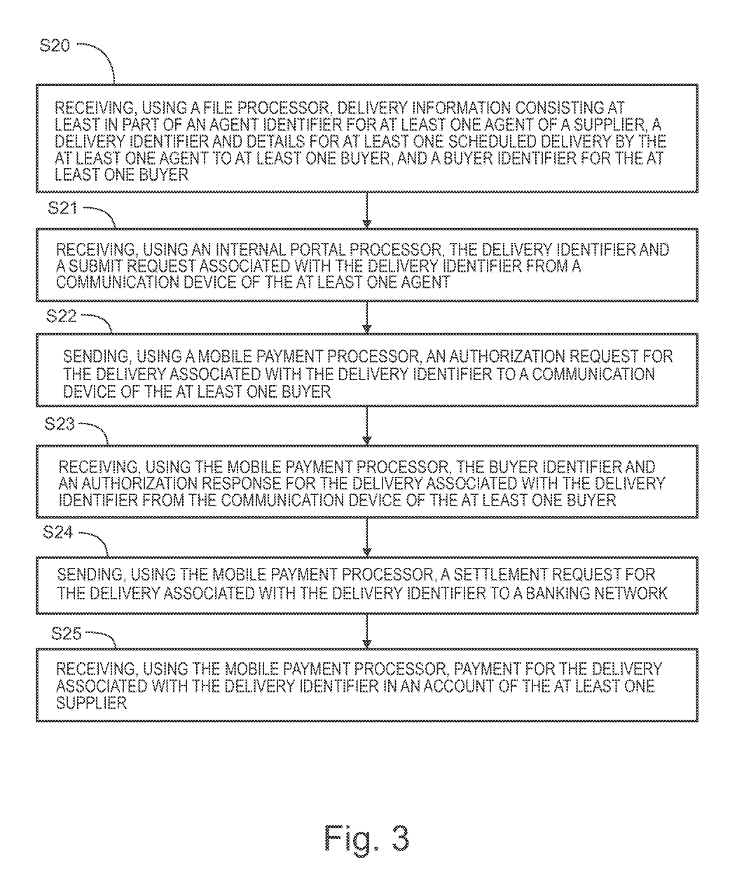

FIG. 3 is a flow chart that illustrates an overview example of the mobile collections process shown in FIGS. 2a and 2b for embodiments of the invention. Referring to FIG. 3, at S20, using a file processor 14, delivery information may be received that consists at least in part of an agent identifier for at least one agent 30 of a supplier 32, a delivery identifier and details for at least one scheduled delivery by the at least one agent 30 to at least one buyer 28, and a buyer identifier for the at least one buyer 28. At S21, using an internal mobile portal processor 16, the delivery identifier and a submit request associated with the delivery identifier may be received from a communication device 40 of the at least one agent 30.

Referring further to FIG. 3, at S22, using a mobile payment processor 18, an authorization request for the delivery associated with the delivery identifier may be sent to a communication device 42 of the at least one buyer 28. At S23, using the mobile payment processor 18, the buyer identifier and an authorization response for the delivery associated with the delivery identifier may be received from the communication device 42 of the at least one buyer 28. At S24, using the mobile payment processor 18, a settlement request for the delivery associated with the delivery identifier may be sent to the banking network 26. At S25, using the mobile payment processor 18, payment for the delivery associated with the delivery identifier may be received in an account of the at least one supplier 32.

Embodiments of the invention provide a mobile based solution that eliminates the handling of physical cash from collection processes, for example, for FMCG merchants. As previously noted, many FMCG suppliers currently operate a COD cash collections service with their customers in which the suppliers' distribution agents collect physical cash from customers at the time of order fulfillment. COD processes have a number of business problems which embodiments of the invention remove or reduce through an automated solution.

For example, aspects of embodiments of the invention eliminate the time that drivers must devote to cash collection and cash delivery, allowing the drivers to focus more time on product delivery. Further, back-office cash-processing activities are reduced and funds are settled in real-time at the point of delivery, removing any delivery fraud and shrinkage opportunities between collection and account settlement. Additionally, immediate transaction confirmation provides an audit trail for the retailer, for the driver, and in the demand deposit account of the supplier.

In additional aspects of embodiments of the invention, retailers enjoy reduced fraud/shrinkage risks, and employee safety is enhanced because even though drivers participate in the receipt of funds, they are never actually in possession of the funds. Real-time electronic processing according to embodiments of the invention eliminates personnel costs associated with cash-handling processes. Further, cash-handling processes for retailers are reduced which increases customer satisfaction. Finally, collections costs are reduced since retailers utilize mobile devices to pay for deliveries.

Thus, benefits of the mobile collections system for embodiments of the invention to customers of the financial institution may include, for example, near real-time settlements, increased working capital efficiency, more efficient delivery-transaction-payment process, and enhanced fraud protection and safety inherent in a cashless operation. Further benefits may include, for example, reduction in operational overheads and preparation for the post-PC era with applications to align with customers' mobile/web availability and adoption strategies. The near real-time settlements with flexible funding sources may also include credit cards, prepaid, mobile wallets, and local country payment/mobile payment solutions.

It is to be understood that embodiments of the invention may be implemented as processes of a computer program product, each process of which is operable on one or more processors either alone on a single physical platform, such as a personal computer, or across a plurality of platforms, such as a system or network, including networks such as the Internet, an intranet, a WAN, a LAN, a cellular network, or any other suitable network. Embodiments of the invention may employ client devices that may each comprise a computer-readable medium, including but not limited to, random access memory (RAM) coupled to a processor. The processor may execute computer-executable program instructions stored in memory. Such processors may include, but are not limited to, a microprocessor, an application specific integrated circuit (ASIC), and or state machines. Such processors may comprise, or may be in communication with, media, such as computer-readable media, which stores instructions that, when executed by the processor, cause the processor to perform one or more of the steps described herein.

It is also to be understood that such computer-readable media may include, but are not limited to, electronic, optical, magnetic, RFID, or other storage or transmission device capable of providing a processor with computer-readable instructions. Other examples of suitable media include, but are not limited to, CD-ROM, DVD, magnetic disk, memory chip, ROM, RAM, ASIC, a configured processor, optical media, magnetic media, or any other suitable medium from which a computer processor can read instructions. Embodiments of the invention may employ other forms of such computer-readable media to transmit or carry instructions to a computer, including a router, private or public network, or other transmission device or channel, both wired or wireless. Such instructions may comprise code from any suitable computer programming language including, without limitation, C, C++, C#, Visual Basic, Java, Python, Perl, and JavaScript.

It is to be further understood that client devices that may be employed by embodiments of the invention may also comprise a number of external or internal devices, such as a mouse, a CD-ROM, DVD, keyboard, display, or other input or output devices. In general such client devices may be any suitable type of processor-based platform that is connected to a network and that interacts with one or more application programs and may operate on any suitable operating system. Server devices may also be coupled to the network and, similarly to client devices, such server devices may comprise a processor coupled to a computer-readable medium, such as a random access memory (RAM). Such server devices, which may be a single computer system, may also be implemented as a network of computer processors. Examples of such server devices are servers, mainframe computers, networked computers, a processor-based device, and similar types of systems and devices

What is claimed is:

1. A method for performing mobile collections, comprising:
receiving, using an internal mobile portal processor, an agent identifier, a delivery identifier and a submit request associated with the delivery identifier from a communication device of at least one agent of a supplier;
sending, using a mobile payment processor, an authorization request for a delivery associated with the delivery identifier to a communication device of a buyer;
receiving, using the mobile payment processor, a buyer identifier and an authorization response for a delivery associated with the delivery identifier from the communication device of the buyer;
sending, using the mobile payment processor, a settlement request for the delivery associated with the delivery identifier to a banking network; and
receiving, using the mobile payment processor, payment for the delivery associated with the delivery identifier in an account of the supplier.

2. The method of claim 1, further comprising receiving, using a file processor, delivery information consisting at least in part of the agent identifier, the delivery identifier and details for the delivery by the at least one agent to the buyer, and the buyer identifier.

3. The method of claim 2, wherein receiving the delivery information further comprises receiving the delivery information from the supplier.

4. The method of claim 3, wherein receiving the delivery information further comprises receiving the delivery information from an enterprise resources planning system processor of the supplier.

5. The method of claim 4, wherein receiving the delivery information further comprises receiving order information related to the delivery information by the enterprise resources planning system processor of the supplier from an enterprise resources planning system of the buyer.

6. The method of claim 5, wherein receiving the order information further comprises translating the order information into a file format of the file processor.

7. The method of claim 1, wherein receiving the delivery identifier from the communication device of the agent further comprises receiving the delivery identifier from the agent's mobile phone.

8. The method of claim 7, wherein receiving the delivery identifier from the agent's mobile phone further comprises receiving the delivery identifier from the agent's mobile phone located at premises of the buyer.

9. The method of claim 1, wherein receiving the submit request further comprises presenting details for the delivery on the agent's mobile phone.

10. The method of claim 9, wherein receiving the submit request further comprises receiving delivery detail adjustments entered by the agent on the agent's mobile phone.

11. The method of claim 1, wherein sending the authorization request further comprises receiving details for the delivery from a mobile collections system processor.

12. The method of claim 11, wherein receiving the details for the delivery further comprises associating the delivery identifier with the details for delivery.

13. The method of claim 12, wherein associating the delivery identifier with the details for the delivery further comprises applying transaction rules to the details for the delivery.

14. The method of claim 1, wherein sending the authorization request further comprises sending a message to the buyer's mobile device requesting verification of the delivery.

15. The method of claim 1, wherein receiving the buyer identifier and authorization response further comprises receiving the buyer identifier and authorization response entered on the buyer's mobile phone.

16. The method of claim 1, wherein receiving the buyer identifier and authorization response further comprises verifying the buyer identifier.

17. The method of claim 1, wherein sending the settlement request further comprises sending a transaction confirmation message to a financial institution processor.

18. The method of claim 1, wherein sending the settlement request further comprises sending a transaction confirmation message to the buyer's communication device.

19. The method of claim 1, wherein sending the settlement request further comprises sending the settlement request with transaction information for the delivery via a banking network to a processor of the buyer's bank.

20. The method of claim 19, wherein sending the settlement request further comprises sending a request for a transfer of funds from an account of the buyer to an account of the mobile payment processor.

21. A system for performing mobile collections, comprising:
an internal mobile portal processor coupled to memory and programmed for receiving an agent identifier, a delivery identifier and a submit request associated with the delivery identifier from a communication device of the at least one agent of a supplier; and
a mobile payment processor coupled to memory and programmed for:
sending an authorization request for a delivery associated with the delivery identifier to a communication device of the buyer;
receiving the buyer identifier and an authorization response for the delivery associated with the delivery identifier from the communication device of the buyer;
sending a settlement request for the delivery associated with the delivery identifier to a banking network; and
receiving payment for the delivery associated with the delivery identifier in an account of the supplier.

22. A method for performing mobile collections, comprising:
receiving, using an internal mobile portal processor, an agent identifier, a collection identifier and a submit request associated with the collection identifier from a communication device of an agent of a provider;
sending, using a mobile payment processor, an authorization request for a collection associated with the collection identifier to a communication device of the customer;
receiving, using the mobile payment processor, the customer identifier and an authorization response for the collection associated with the collection identifier from the communication device of the customer;
sending, using the mobile payment processor, a settlement request for the collection associated with the collection identifier to a banking network; and
receiving, using the mobile payment processor, payment for the collection associated with the collection identifier in an account of the provider.
